(19) United States
(12) Patent Application Publication
(10) Pub. No.: US 2014/0241315 A1
(43) Pub. Date: Aug. 28, 2014

(54) RADIO ACCESS NETWORK (RAN) FOR PEER-TO-PEER (P2P) COMMUNICATION

(71) Applicants: Huaning Niu, Milpitas, CA (US); Hujun Yin, Saratoga, CA (US); Geng Wu, Plano, TX (US)

(72) Inventors: Huaning Niu, Milpitas, CA (US); Hujun Yin, Saratoga, CA (US); Geng Wu, Plano, TX (US)

(21) Appl. No.: 13/997,254

(22) PCT Filed: Sep. 30, 2011
(86) PCT No.: PCT/US2011/054455

§ 371 Date: Apr. 21, 2014

(51) Int. Cl. H04L 29/08; H04W 36/00; H04W 76/02

(52) U.S. Cl. CPC H04L 29/08306; H04W 76/023; H04W 36/0011
USPC 370/331; 370/328

(57) ABSTRACT

A serving gateway (S-GW) in a radio access network (RAN) server system for peer-to-peer (P2P) communication can include a P2P content manager. The P2P content manager can be configured for receiving P2P data content from other nodes in a P2P network, forwarding the P2P data content to other nodes in the P2P network, and transmitting the P2P data content to a mobile device associated with the S-GW in a downlink (DL) transmission. The serving gateway can be a node in the P2P network and coupled to a transmission station in the RAN. The P2P data content includes at least one P2P data packet.

### BACKGROUND

Wireless mobile communication technology uses various standards and protocols to transmit data between a transmission station and a wireless mobile device. Some wireless devices communicate using an orthogonal frequency-division multiplexing (OFDM) digital modulation scheme via a physical layer. OFDM standards and protocols can include the third generation partnership project (3GPP) long term evolution (LTE), the Institute of Electrical and Electronics Engineers (IEEE) 802.16 standard (e.g., 802.16e, 802.16m), which is commonly known to industry groups as WiMAX (Worldwide interoperability for Microwave Access), and the IEEE 802.11 standard, which is commonly known to industry groups as WiFi. In 3GPP radio access networks (RANs) in LTE systems, the transmission station can be a combination of evolved Node Bs (also commonly denoted as enhanced Node Bs, eNodeBs, or eNBs) and Radio Network Controllers (RNCs) in a Universal Terrestrial Radio Access Network (UTRAN), which communicates with the wireless mobile device, known as a user equipment (UE). A downlink (DL) transmission can be a communication from the transmission station (or eNodeB) to the wireless mobile device (or UE), and an uplink (UL) transmission can be a communication from the wireless mobile device to the transmission station.

With the proliferation of mobile devices with video, photographic, and audio capabilities and the applications that utilize these capabilities, mobile devices have rapidly consumed resources on the mobile broadband internet. The proliferation of data transmissions, such as multimedia, video, and audio streaming, transmitted and received by mobile devices on the mobile broadband internet has increased the mobile internet traffic and load on the backhaul traffic in the core network. Various network architectures can be used to manage the mobile broadband internet.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1A illustrates a block diagram of a single tree based peer-to-peer (P2P) architecture in accordance with an example;

FIG. 1B illustrates a block diagram of a multi-tree based peer-to-peer (P2P) architecture in accordance with an example;

FIG. 2 illustrates a block diagram of a mesh-pull based peer-to-peer (P2P) architecture in accordance with an example;

FIG. 3 illustrates a block diagram of a peer-to-peer (P2P) architecture with a radio access network (RAN) in accordance with an example;

FIG. 4A illustrates a block diagram of a radio access network (RAN) server system in accordance with an example;

FIG. 4B illustrates a block diagram of a serving gateway (S-GW) in accordance with an example;

FIG. 5 illustrates a block diagram of a base band unit (BBU) and a remote radio unit (RRU) configuration of a centralized radio access network (C-RAN) in accordance with an example;

FIG. 6 depicts a flow chart of a method for peer-to-peer (P2P) communication in a radio access network (RAN) in accordance with an example;

FIG. 7 depicts a flow chart of a method for peer-to-peer (P2P) communication in a radio access network (RAN) in accordance with an example; and

FIG. 8 illustrates a diagram of a mobile device in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### EXAMPLE EMBODIMENTS

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Peer-to-peer (P2P) communication protocols are used in physically connected internet protocol (IP) broadband networks to reduce backhaul traffic between core network components connected via wires, cabling, or optical fiber. As the functionality of mobile devices improves, users are gradually using the mobile internet on their mobile devices similar to their use of devices on the fixed broadband network, Non-P2P communication networks (including router-based architectures) typically provide direct or dedicated delivery infrastructure from a source to a destination. So when a popular stream or file is requested, duplicate data packets are transmitted from the source to each destination requesting the data packets, which can add to the congestion of the backhaul traffic, P2P content networks do not rely on a dedicated delivery infrastructure. P2P content networks (or P2P networks) provide a distributive delivery infrastructure, where each requester of content can participate in the delivery by forwarding the received content to other requesters. For a popular stream or file, a P2P participant can receive the content from another participant that can be at a closer location to the P2P participant than the original source or host of the content, thus P2P content networks can reduce backhaul traffic on the broadband network. The P2P architecture can leverage the bandwidth resources of end systems actually participating in the communication. Content services delivered through the web and P2P networks continue to occupy a greater percentage of the network traffic.

Typically, mobile devices do not participate in a P2P network, since a P2P node not only downloads the requested P2P content but also uploads the P2P content to other nodes requesting the same P2P content. The data rates for downlinks (analogous to downloads) from a transmission station to a mobile device can be faster than uplinks (analogous to uploads) from the mobile station to the transmission station. In addition, the mobile station usually operates off a battery or other small electrical storage device, which can limit the power available for the uplink transmission. The slower uplink data rates and power limitations of the mobile device, can exclude the mobile device from being a node in the P2P network.

A radio access network (RAN) server system associated with the mobile device can provide a node in the P2P network using a serving gateway (S-GW). The S-GW can be linked to a transmission station in the RAN, which can be in wireless communication with the mobile device. The S-GW can provide for P2P communication using a P2P content manager. The P2P content manager can be configured for receiving P2P data content from other nodes in a P2P network, forwarding the P2P data content to other nodes in the P2P network, and transmitting the P2P data content to the mobile device associated with the S-GW in a downlink transmission. The P2P data content can include at least one P2P data packet.

To better under the functionality of the P2P content manager in the S-GW, the purpose and components of P2P network are briefly reviewed. The P2P network may not utilize support from internet routers and the network infrastructure like router-based architectures, thus P2P networks can be extremely cost-effective and easy to deploy. In the P2P network, a participant (or node) that requests a broadcast may download the data content and also upload the data content to other participants (or other nodes) requesting the same data content. The P2P network can be used for broadcast and multicast data content. Broadcast can refer to a large number of destinations requesting the data content and multicast can refer to a group of destinations requesting the data content. The multicast can have fewer participants than the broadcast. Many broadcast and multicast applications, such as video streaming, can impose stringent real-time performance requirements in terms of bandwidth and latency. The P2P network can be used to improve bandwidth and latency of these applications.

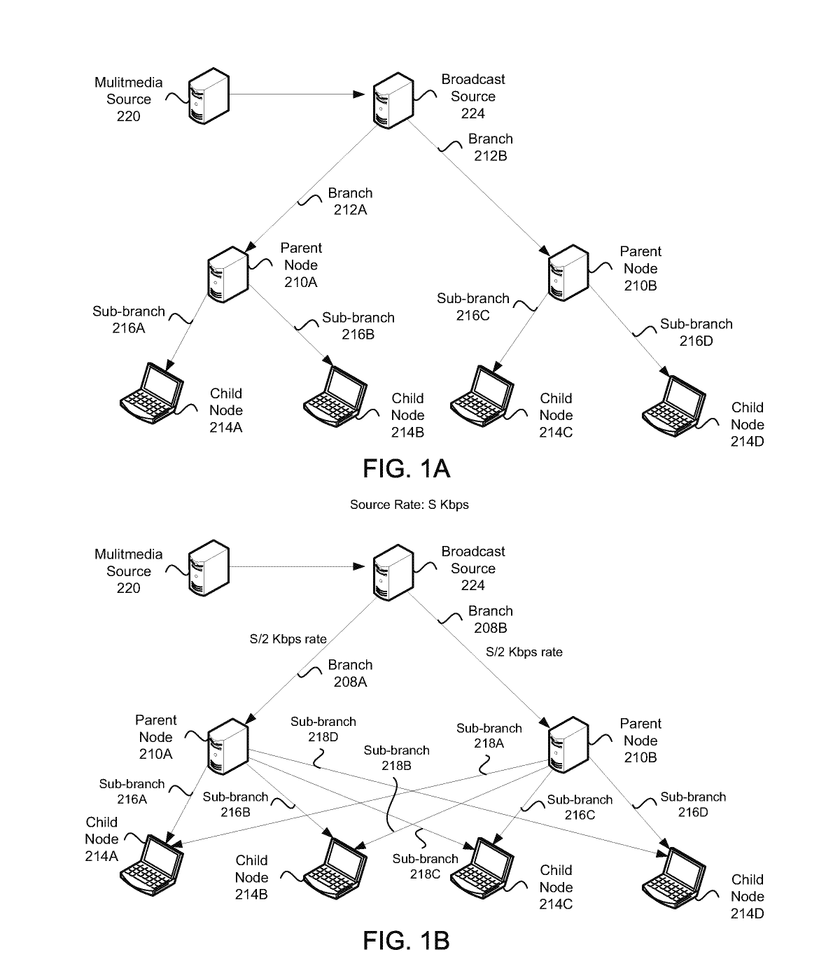

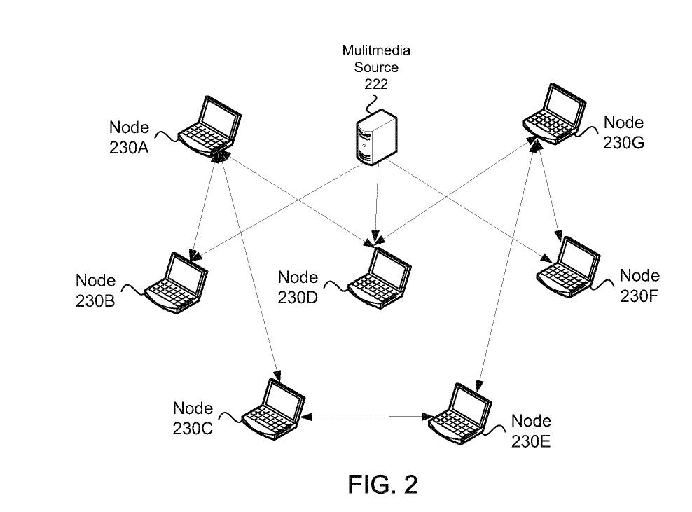

Two kinds of P2P architecture include a tree based P2P architecture, illustrated in FIGS. 1A and 1B, and a mesh-pull based overlay P2P architecture (or data-driven randomized P2P architecture). illustrated in FIG. 2. In the tree base P2P architecture, nodes on the structure can have well-defined relationships, for example, “parent-child” relationships in trees. The tree base P2P architecture are typically push-based, that is, when a node receives a data packet, the node also forwards copies of the packet to each of the node's children. The tree-based architecture can be further subdivided into a single-tree-based architecture or a multi-tree-based architecture. In the single tree base P2P architecture example shown in FIG. 1A, a multimedia source 220, such as a video source, can be coupled to a broadcast source 224 that can transmit the P2P content via branches 212A-B to parent nodes 210A-B, which can the forward the P2P content to child nodes 214A-D via sub-branches 216A-D. In another example, the multimedia source and the broadcast source can be embodied in the same device. In an example, the multimedia source may be a single dedicated source or may be generated from multiple sources. In the tree base P2P architecture, the structure can continually be reorganized to maintain the structure, as nodes join and leave the group at will. If a node, such as a parent node, crashes or otherwise stops performing adequately, the node's offspring in the tree can stop receiving packets until the tree is repaired or reorganized. The tree based structure can constantly be repaired or reorganized in the highly dynamic peer-to-peer environment. A network architecture can be optimized for various purposes, such as bandwidth or delay. The tree-based architecture can be optimized primarily for bandwidth and secondarily for delay. The single-tree-based approach can suffer from disruptive delivery due to failures of parent or high-level nodes and underutilized outgoing bandwidth in a child or leaf nodes.

The multi-tree based architecture can provide a more resilient structure where the broadcast source encodes the stream into substreams and distributes each substream along a particular overlay tree. The multi-tree based architecture can improve the overall resiliency of the system, as a node may not be completely disrupted by the failure of an ancestor node on a given tree, and the potential bandwidth of nodes can be more fully utilized, as long as each node is not a leaf in at least one tree.

FIG. 1B illustrates how P2P content (or broadcast content) is delivered with a multi-tree based architecture using two trees stemming from parent nodes 210A-B, where sub-branch 218A-D provides a redundant path in addition to a primary path 216A-D to the child nodes 214A-D. The broadcast source can distribute a stream rate S/2 over each tree, where S is the source rate. A child node can receive S/2 from each tree, with potentially different parents to reconstruct the original content. Parent nodes 210A and 210B each can contribute a bandwidth S/2 and allocate their bandwidth in a first tree (branch 208A) and a second tree (branch 208B), respectively.

In contrast to the tree based P2P architecture, FIG. 2 illustrates a mesh-pull based P2P architecture, where nodes 230A-G can be connected directly to the multimedia source 222 or indirectly through other nodes to receive P2P content. An overlay network can utilize the structure of an existing network and organize the elements to provide a specified function, such as P2P communication. The P2P network can be an overlay network. The P2P network can use a P2P mesh-pull protocol. P2P network deployments can include PPlive, BitTorrent, EMule, Chainsaw, and CoolStreaming protocols using the mesh-pull architecture. The P2P network can use gossip algorithms to generate and maintain connectivity between nodes and the source, such as a multimedia source. More explicitly, nodes can maintain a set of partners and periodically exchange data availability information with the partners. A node may then retrieve unavailable data from one or more partners or supply available data to those partners. Redundancy can be avoided or reduced, as the node pulls data, if the node does not already possess the data. Modules in a P2P node can include a membership manager, a partnership manager, and a scheduler. The membership manager can help the node maintain a partial view of other overlay nodes. The partnership manager can establish and maintain partnership with other nodes. The scheduler can schedule the transmission of the P2P content, such as video data. In some P2P protocols, the P2P content, such as a video stream, can be divided into segments of a uniform length, and the availability of the active segments in a buffer of the node can be represented by a buffer map (BM). Each node can continuously exchange the node's BM with the node's partners. The node can then determine which segment is to be fetched from which partner. Timely and continuous segment delivery can be valuable in some P2P applications, such as a video broadcast, but may not be as valuable for other applications, such as a file download. In time sensitive P2P applications, a segment downloaded after the segments playback time may be useless. A buffer in the scheduler can maintain playback deadlines for time sensitive P2P application segments, and the scheduler can balance the constraints of meeting the playback deadline for each segment and providing the heterogeneous streaming bandwidth from the node's partners.

In mesh pull networks, each node can contribute to the upload traffic at the same time the node is receiving a download. For wired network components, simultaneous or near simultaneous transmission of upload traffic with reception of download traffic can be achieved with relative ease since different transmission paths can be used for uploads and downloads. The network bottle neck can be at the backhaul for wired network. In a hierarchical telecommunications network the backhaul portion of the network can include the intermediate links between the core network, or backbone, of the network and the small subnetworks or nodes at the “edge” of the hierarchical network. A wired network can refer to any network using a fixed connection, such as electrical wire or optical fiber.

In a wireless network (or cellular network), the bottleneck may not be at the backhaul, rather at a radio access network (RAN). In the RAN, an uplink (UL) data rate can be small compared to a downlink (DL) data rate since UL transmit power of the mobile device can be much less than the DL transmit power of the transmission station. Mobile device typically operate off batteries and other electrical storage devices, which can limit the mobile device's UL transmission power, while transmission stations can operate off commercial grid power or similar power source, so the downlink transmission power can be much greater than the uplink transmission power. The RAN can be linked to a wired network or an external packet data network. The RAN can be adapted operate as a P2P node and reduce the uplink traffic of the mobile devices associated with the RAN.

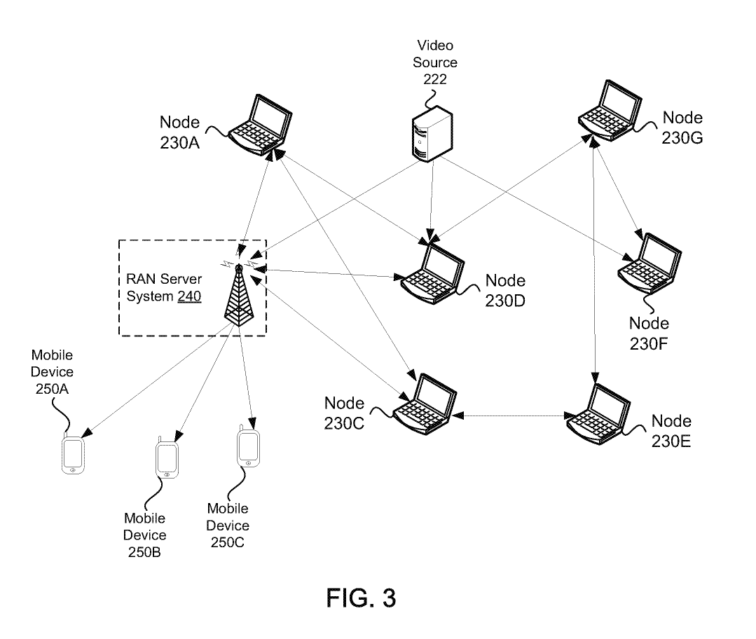

The RAN can use a hybrid architecture with tree-based features and mesh-pull based features to support P2P service in the RAN. FIG. 3 illustrates a RAN server system 240 for P2P communication with mobile devices 250A-C in the P2P network. The RAN server system can operate as a mesh-pull node to other nodes 230A and 230C-G in a P2P network. The RAN server system can operate as a super tree node (parent tree based node) to the mobile devices associated with the RAN server system where the associated mobile devices can be child nodes that do not contribute or contribute little to the P2P uplink traffic. The RAN server system can form the P2P network with other heterogeneous nodes such as digital subscriber line (DSL), cable model, fiber connected television (TV), a personal computer (PC), and similar network devices using the mesh-pull overlay. Digital subscriber line (DSL) can be a family of technologies that provides digital data transmission over the wires of a local telephone network. The a RAN node and other nodes can use TCP/IP communication protocols for data transmission in the Internet and other similar networks, where TCP/IP protocol suite can include a transmission control protocol (TCP) and/or an internet protocol (IP).

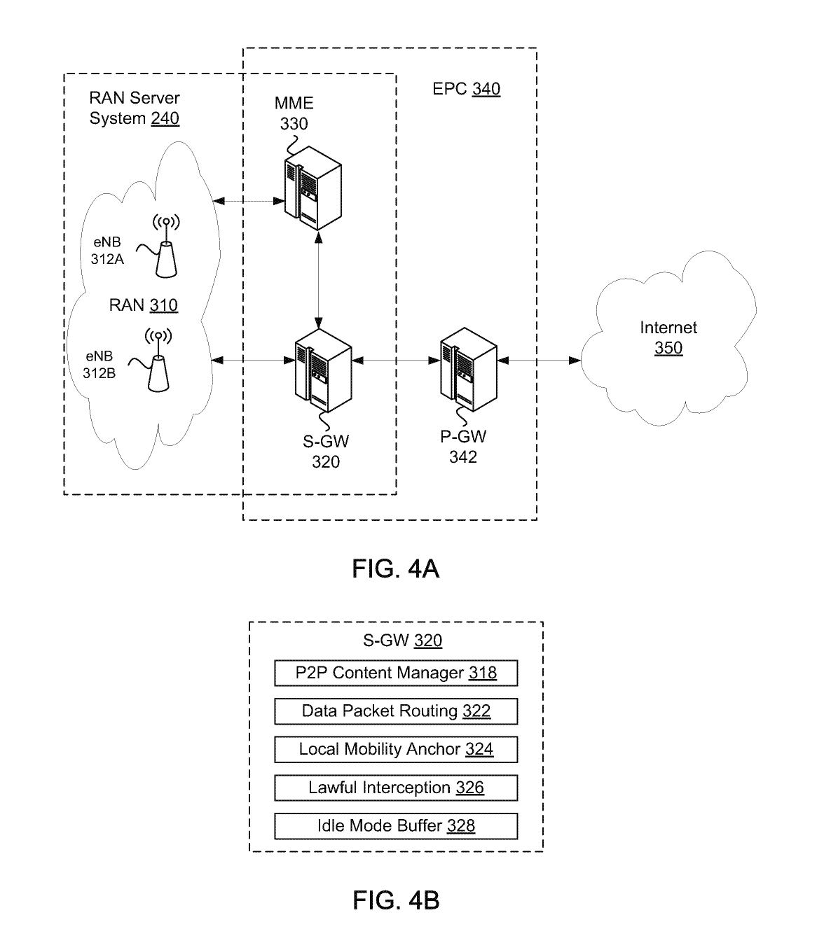

The P2P service for the RAN server system 240 can be provided by a serving gateway (S-GW) 320, illustrated in FIGS. 4A and 4B. The S-GW can be a node in the P2P network and coupled to a transmission station in a radio access network (RAN). FIG. 4A illustrates a 3GPP LTE RAN server system. For 3G PP LTE, the RAN server system can include evolved universal terrestrial radio access (E-UTRAN or eUTRAN) or UTRAN modules and evolved packet core (EPC) modules. For example, the S-GW and a mobility management entity (MME) 330 of the RAN server system can also be included an EPC 340 for the RAN. The EPC can also include a packet data network (PDN) gateway (P-GW) 342 to couple the S-GW to a PDN, such as the Internet 350, an intranet, or other similar network. The RAN server system can include an eNB 312A-B in a RAN 310 where the S-GW and MME are coupled to the eNB and the RAN. The S-GW can provide P2P network access and standard network access for the mobile devices associated with the RAN. The S-GW and MME can be in direct communication with each other via cabling, wire, optical fiber, and/or transmission hardware, such a router or repeater.

FIG. 4B illustrates modules and functions that can be performed by the S-GW 320. The S-GW can include a P2P content manager 318, a data packet routing module 322, a local mobility anchor module 324, a lawful inception module 326, and/or an idle mode buffer module 328. The data packet routing module can route and forward standard mobile device data packets. The local mobility anchor module can anchor the mobile device to the RAN server system during an inter-eNB handover and anchor the mobile device for mobility between wireless standards. The lawful inception module can provide lawful replication of mobile device traffic. The idle mode buffer module can terminate a downlink data path for the mobile device and trigger paging of the mobile device when downlink data arrives at the RAN server system. The S-GW can manage and store mobile device context information, such as parameters of the IP bearer service and network internal routing information.

The P2P content manager 318 can receive the P2P data content from other nodes in a P2P network, forward the P2P data content to other nodes in the P2P network, and transmit the P2P data content to a mobile device associated with the serving gateway in a downlink (DL) transmission. The P2P data content can include at least one P2P data packet. A P2P data packet can have a different structure than the standard mobile device data packet and/or the data packet can include information or indicators that can alert the P2P node to handle the data packet as P2P content. The P2P data content can include a multimedia stream, a video stream, an audio stream, a graphics file, an audio file, a text the, an executable file, a multimedia file, or combinations these files or streams.

The P2P content manager 318 can include a tracking server, a channel server, a buffer mapper, a P2P streaming engine, a media player, a membership manager, a partnership manager, and/or a scheduler, depending on the P2P protocol or implementation used. The tracking server can maintain a list of the nodes requesting the P2P data content and a list of the nodes that previously retrieved the P2P data content. The channel server can store the P2P data content and/or the original P2P data content from the mobile device in an uplink (UL) transmission. The buffer mapper can retrieve and store the buffer maps of P2P data content of other nodes. The P2P streaming engine can cache or buffer P2P data content for other nodes. The media player can buffer P2P data content for a downlink transmission to the mobile device.

Using the S-GW 320 as a node for P2P communication can limit the mobile device uplink traffic and improve the overall system capacity. Because the uplink traffic of mobile device can be reduced, the transmission power of the mobile device can be reduced. As a result, the battery life of the mobile device can be extended for the same or similar mobile device functionality. In addition, the backhaul traffic can be reduced by buffering popular P2P content at the S-GW of the RAN server system. As a P2P node, the S-GW can allow mobile devices to participate indirectly in the P2P network. The S-GW for P2P communication can reduce a P2P application response time and improve user experience because the popular P2P content can be buffered at the S-GW or other nodes closer than the original source of the P2P content.

Referring back to FIG. 4A, S-GW 320 can be included within the RAN server system 240. The S-GW can handle user data functionality and routing and forwarding of data to the P-GW 342. The RAN server system can include a transmission station (e.g., eNB 312A-B) linked to the S-GW for providing uplink and downlink connectivity from the serving gateway to the mobile device. An uplink transmission can include a request from the mobile device to the S-GW for the P2P data content and a downlink transmission can include the P2P data content. The mobile device may be associated with one S-GW at any instance. The S-GW can operate as a super node for the P2P network for the mobile devices associated with the S-GW. The S-GW can buffer P2P data and forward the P2P downlink traffic to the mobile device at or near the same time as the S-GW shares or uploads the P2P content with other nodes with few or no mobile device uplink P2P transmissions. The P2P downlink transmission can be transmitted in a unicast subframe to the mobile device or multicast subframe to multiple devices requesting the P2P content.

The RAN server system 240 and EPC 340 can include the MME 330 to handle the mobility related signaling functionality. In LTE, the MME can be a control node to the RAN. The MME can provide for mobile device idle mode tracking and paging, data retransmissions to the mobile device, mobile device authenticating, inter-core network handover tracking of the mobile device, or combinations of these functions. The MME can be involved in a bearer activation/deactivation process and in choosing the S-GW for the mobile device at the initial attachment and during core network (CN) node relocation. The MME can generate and allocate temporary identities to the mobile devices. The MME can enforce mobile device roaming restrictions. The MME can handle the security key management and lawful interception signaling.

The S-GW 320 can be linked to the P2P network and an external packet data network via the P-GW 342 of the EPC 340. The P-GW can perform policy enforcement, packet filtering for each user, charging support, lawful interception, and/or packet screening. The external packet data network can be the Internet 350, the intra-net, or other similar network. The P-GW can provide connectivity from the mobile device to the external packet data networks by being the point of exit and entry of traffic for the mobile device. The mobile device may have simultaneous connectivity with more than one P-GW for accessing multiple PDNs. The P-GW can operate as an anchor for mobility between wireless standards.

When the mobile device generates P2P content, the P2P content can be transmitted once to the S-GW via an uplink transmission and stored at the S-GW. The mobile uplink P2P content can be stored by a channel server or other P2P module for storing original mobile uplink P2P content within the S-GW. The uplink transmission can occur as the result of a request or initiated by the mobile device. When the uplink P2P content is requested by a P2P node, the S-GW forwards the uplink IPP content without an additional uplink transmission from the mobile device. When the uplink P2P content is requested by a P2P another mobile device in RAN server system, the S-GW provides a downlink transmission of the uplink P2P content without an additional uplink transmission from the mobile device. When the mobile device moves or relocates to another RAN or RAN server system, the uplink P2P content may remain at an originating RAN or RAN server system, or the uplink P2P content may be copied to and stored at the RAN or RAN server system associated with the relocated mobile device. In another example, the uplink P2P content can be stored at the home RAN server system of the mobile device.

The RAN for P2P communication can be implemented using a centralized, cooperative, or cloud radio access network (C-RAN). In the C-RAN, the transmission station (or eNodeB) functionality can be subdivided between a base band unit (BBU) processing pool and a remote radio unit (RRU) or a remote radio head (RRH) with optical fiber connecting the BBU to the RRU. The BBUs and the RRUs of the C-RAN, the S-GW, and the MME can be included in the RAN server system, The RAN server system can be referred to a C-RAN server farm when the RAN is implemented using a C-RAN. The purpose and components of a C-RAN are briefly reviewed.

The proliferation of the mobile broadband internet has increased the mobile internet traffic and load on the transmission station, such as an eNodeB, and the core network in the RAN. A typical RAN architecture can include an eNodeB which connects to a fixed number of sector antennas that can cover a small area and that can handle transmission/reception signals in the sector coverage area. In addition, the typical RAN can be limited by interference, so improving spectrum capacity can be limited.

C-RAN can provide centralized processing, co-operative radio, and real-time cloud infrastructure RAN. Centralized signal processing can greatly reduce the number of site equipment rooms needed to cover the same area as a traditional RAN. Co-operative radio with distributed antenna equipped by a remote radio unit (RRU) can provides higher spectrum efficiency than the traditional RAN. A real-time cloud infrastructure based on an open platform and transmission station virtualization can enable processing power aggregation and dynamic allocation, which can reduce the power consumption and increase infrastructure utilization rate, C-RAN can provide reduced cost and lower energy consumption, higher spectral efficiency, support multiple standards and smooth evolution, and better internet services to end users.

A typical characteristic of a mobile network is that mobile devices frequently move from one place to another. The movement of mobile devices can have a time-geometry trend. During work hours, a large number of mobile devices move from residential areas to central office areas and industrial areas for work. During evening hours or non-work hours, mobile devices move back to the residential areas (e.g., homes) or entertainment areas. Thus, the network load moves in the mobile network with a similar pattern. More specifically, each eNodeB's processing capability may be used by the active mobile devices within the eNodeB's cell range. When mobile devices move outside the eNodeB's cell range, the eNodeB can remain idle with a large portion of the eNodeB's processing power wasted. In a macro view of the mobile network, the eNodeBs in residential areas or entertainment areas may be largely idle during work hours, and the eNodeBs in central office areas and industrial areas may be largely idle during non-work hours. The C-RAN architecture can allow eNodeB processing to be utilized in both the residential and/or entertainment areas and the central office and/or industrial areas during both work hours and non-work hours, thus balancing the network load and reducing the idle time of eNodeB processors and increasing the coverage area of the eNodeB.

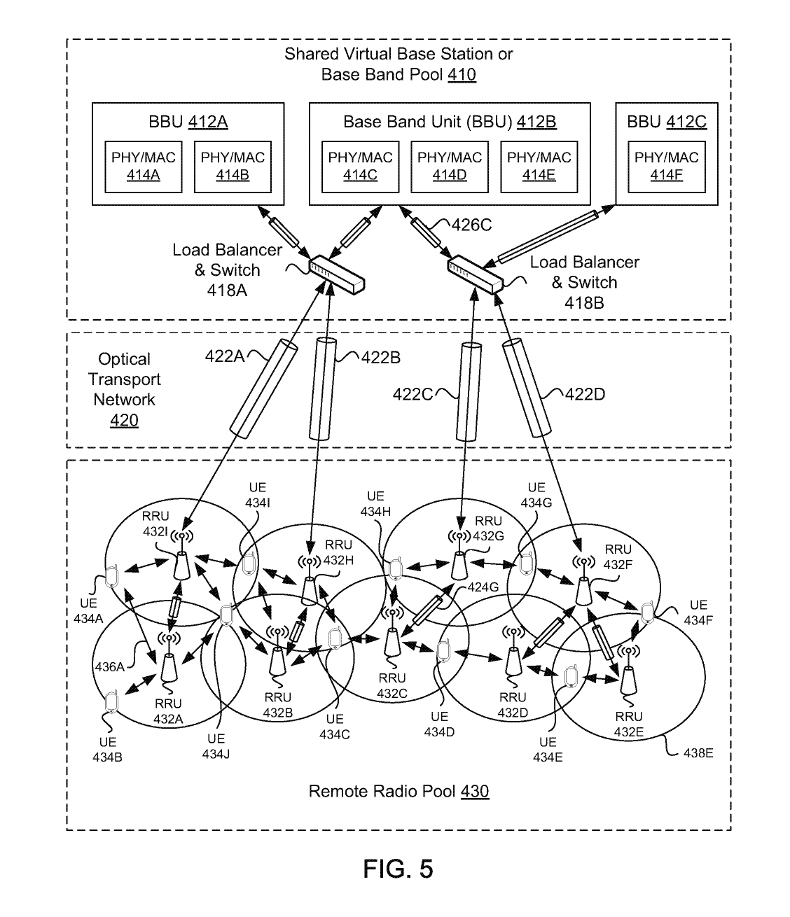

As illustrated in FIG. 5. the C-RAN can be composed of three parts: a remote radio pool 430 equipped by remote radio units (RRUs) 432A-I with antennas, a shared virtual base station or a base band processing pool 410 including base-band units (BBUs) 412A-C, and a fiber or cable 422A-D and 424G in a physical transport network 420 connecting at least one of the RRUs in the remote radio pool to at least one of the BBUs in the base band pool. The base band processing pool can be centralized. Each BBU can include a high-performance general purpose processor, a real-time virtualization processor, and/or a physical (PHY) layer processor and/or a MAC layer processor 414A-F. The BBUs can be coupled to a load balancer and switch 418A-B via electrical or optical cabling 426C. The physical transport network can be a low-latency transport network, a bandwidth-efficient network, and/or an optical transport network 420 using optical fiber or optical cabling. In another example, the physical transport network can be a high speed electrical transport network. The physical transport network can provide a physical communication link between the BBU and the RRU. The physical communication link can include an optical fiber link or a wired electrical link. The BBU can be referred to as a radio element controller (REC). The RRU can be referred to as a remote radio head (RRH), a remote radio equipment (RRE), a relay station (RS), or a radio equipment (RE). Each RRU can be separated from the BBU by a selected distance. For example, each RRU may be separated from a BBU by at least 50 meters. However, the actual design and layout can depend on system specifications. The actual distance of each RRU may be greater than or less than 50 meters. Each RRU can include a sector, cell, or coverage area 438E for a mobile device, such as a user equipment (UE) 434A-J, where the mobile device may be located within multiple sectors, cells, or coverage areas. The distributed RRUs of the C-RAN can provide a RAN with high capacity and a wide coverage area.

RRUs 432A-I can be smaller, easier to install, easier to maintain, and consume less power than the BBUs 412A-C. The base band processing pool 110 can aggregate the processing power of the BBU through real-time virtualization technology and provide the signal processing capacity to the virtual BTSs or RRUs in the pool. The physical transport network can distribute the processed signals to the RRUs in the remote radio pool 430. The centralized BBU pool can reduce the number of transmission station rooms used for BBUs and can make resource aggregation and large-scale cooperative radio transmission/reception possible. The C-RAN can dynamically switch the S-GW's connectivity from a first BBU to a second BBU in the BBU pool. In another example, the C-RAN can dynamically switch a BBU's connectivity from a first RRU to a second RRU in the RRU pool.

The S-GW can provide P2P node functionality to the BBU pool of the C-RAN. The BBU pool and/or RRU pool can provide redundant tree-based node functionality to the mobile devices, similar to a multi-tree P2P network. In another example, a BBU in the BBU pool and/or a RRU in the RRU pool can provide tree-based node functionality to the mobile devices, similar to a single tree P2P network.

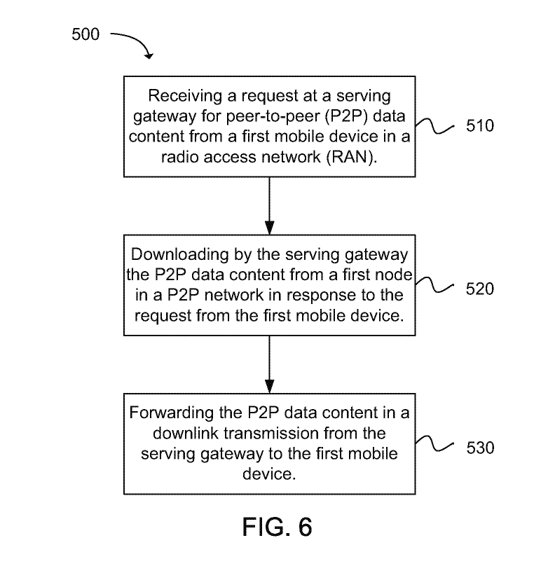

Another example provides a method 500 for P2P communication in the RAN, as shown in the flow chart in FIG. 6. The method includes the operation of receiving a request at a serving gateway for peer-to-peer (P2P) data content from a first mobile device in a radio access network (RAN), as in block 510. The operation of downloading by the serving gateway the P2P data content from a first node in a P2P network in response to the request from the first mobile device follows, as in block 520. The next operation of the method can be forwarding the P2P data content in a downlink transmission from the serving gateway to the first mobile device, as in block 530.

The operation of downloading the P2P data content can use a P2P mesh-pull protocol. The P2P data content can include a multimedia stream, a video stream, an audio stream, a graphics file, an audio file, a text file, an executable file, a multimedia file, or combinations these files or streams. The method 500 can further include the operation of buffering or caching the P2P data content downloaded by the serving gateway for a minimum specified time. Another operation of the method can include forwarding the P2P data content in a cache to a second node in the P2P network in response to a request by the second node for the P2P data content originally requested by the first mobile device. The operation of forwarding the P2P data content in a cache to a second mobile device in the RAN in a downlink transmission in response to a request by the second mobile device for the P2P data content originally requested by the first mobile device can also be included.

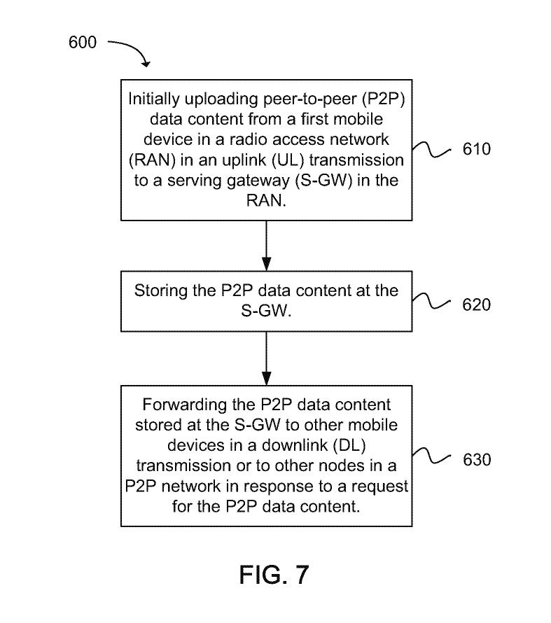

Another example provides a method 600 for P2P communication in the RAN, as shown in the flow chart in FIG. 7. The method includes the operation of initially uploading peer-to-peer (P2P) data content from a first mobile device in a radio access network (RAN) in an uplink (UL) transmission to a serving gateway (S-GW) in the RAN, as in block 610. The operation of storing the P2P data content at the S-GW follows, as in block 620. The next operation of the method can be forwarding the P2P data content stored at the S-GW to other mobile devices in a downlink (DL) transmission or to other nodes in a P2P network in response to a request for the P2P data content, as in block 630.

The operation of downloading the P2P data content can use a P2P mesh-pull protocol. The request for the P2P data content from other mobile devices or other nodes can be directed to the first mobile device and serviced by the S-GW.

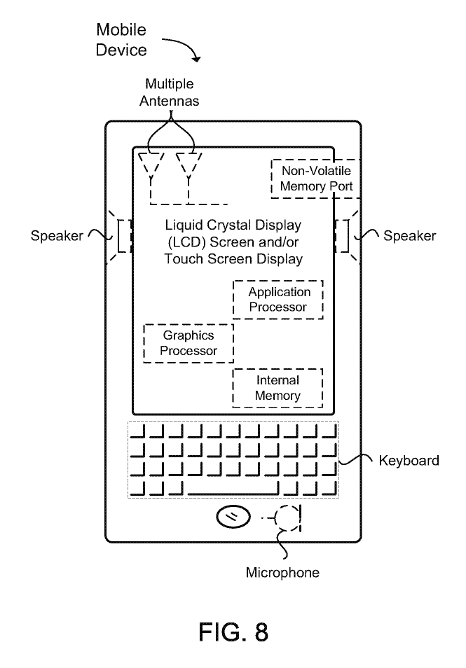

In another example, the S-GW of the RAN can be in wireless communication with the mobile device via the transmission station. FIG. 8 provides an example illustration of the mobile device, such as a user equipment (UE), a mobile station (MS), a mobile wireless device, a mobile communication device, a tablet, a handset, or other type of mobile wireless device. The mobile device can include one or more antennas configured to communicate with transmission station, such as a base station (BS), an evolved Node B (eNB), a base band unit (BBU), a remote radio head (RRH), a remote radio equipment (RRE), a relay station (RS), a radio equipment (RE), or other type of wireless wide area network (WWAN) access point. The mobile device can be configured to communicate using at least one wireless communication standard including 3GPP LTE, WIMAX, High Speed Packet Access (HSPA), Bluetooth, and WiFi. The mobile device can communicate using separate antennas for each wireless communication standard or shared antennas for multiple wireless communication standards. The mobile device can communicate in a wireless local area network (WLAN), a wireless personal area network (WPAN), and/or a WWAN.

FIG. 8 also provides an illustration of a microphone and one or more speakers that can be used for audio input and output from the mobile device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The base station and mobile station may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” means that a particular feature, structure, or characteristic described in connection with the example is included in at least one embodiment of the present invention. Thus, appearances of the phrases in “van example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form. usage and details of implementation can be made without the exercise of inventive faculty, and without departing from the principles and concepts of the invention. Accordingly, it is not intended that the invention be limited, except as by the claims set forth below.

What is claimed is:

1. A serving gateway (S-GW) in a radio access network (RAN) server system for peer-to-peer (P2P) communication, comprising:
a peer-to-peer (P2P) content manager for:
receiving P2P data content from other nodes in a P2P network;
forwarding the P2P data content to other nodes in the P2P network; and
transmitting, via a transmission station in a radio access network (RAN), the P2P data content to a mobile device associated with the serving gateway for a downlink transmission;
wherein the serving gateway is a node in the P2P network, the serving gateway is coupled to a transmission station, and the P2P data content includes at least one P2P data packet.

2. The serving gateway of claim 1, further comprising:
a data packet routing module for routing and forwarding standard mobile device data packets;
a local mobility anchor module for anchoring the mobile device to the RAN server system during an inter-transmission station handover and anchoring the mobile device for mobility between wireless standards;
a lawful inception module for providing lawful replication of mobile device traffic; and
an idle mode buffer module for terminating a downlink data path for the mobile device and triggering paging of the mobile device when downlink data arrives at the RAN server system.

3. The serving gateway of claim 1, wherein the P2P network uses a P2P mesh-pull protocol.

4. The serving gateway of claim 8, wherein the P2P mesh-pull protocol includes PPlive or BitTorrent.

5. The serving gateway of claim 1, wherein the P2P content manager includes a IPP module selected from the group consisting of a tracking server for maintaining a list of the nodes requesting the P2P data content and a list of the nodes that previously retrieved the P2P data content, a channel server for storing the P2P data content and/or the original P2P data content of the mobile device in an uplink transmission, a buffer mapper for retrieving and storing the buffer maps of P2P data content of other nodes, a P2P streaming engine for caching P2P data content, a media player for buffering P2P data content for a downlink transmission to the mobile device, and combinations thereof.

6. The serving gateway of claim 1, wherein the P2P data content is selected from the group consisting of a multimedia stream, a video stream, an audio stream, a graphics file, an audio file, a text file, an executable file, a multimedia file, and combinations thereof.

7. The serving gateway of claim 1, wherein the serving gateway provides network access for a plurality of mobile devices.

8. The serving gateway of claim 1, wherein the mobile device is selected from the group consisting of a user equipment (UE) and mobile station (MS).

9. The serving gateway of claim 1, wherein the mobile device is configured to connect to at least one of a wireless local area network (WLAN), a wireless personal area network (WPAN), and a wireless wide area network (WWAN), and the mobile device includes an antenna, a touch sensitive display screen, a speaker, a microphone, a graphics processor, an application processor, internal memory, a non-volatile memory port, or combinations thereof.

10. A computer program product, comprising a non-transitory computer readable storage medium having a computer readable program code embodied therein, the computer readable program code adapted to be executed to implement a method for peer-to-peer (P2P) communication in a radio access network (RAN), comprising:
receiving a request at a serving gateway for peer-to-peer (P2P) data content from a first mobile device in a radio access network (RAN);
downloading by the serving gateway the P2P data content from a first node in a P2P network in response to the request from the first mobile device; and
forwarding the P2P data content in a downlink transmission from the serving gateway to the first mobile device.

11. The computer program product of claim 10, further comprising buffering or caching, at the serving gateway, the P2P data content downloaded by the serving gateway for a minimum specified time.

12. The computer program product of claim 10, further comprising forwarding the P2P data content in a cache on the serving gateway to a second node in the P2P network in response to a request by the second node for the P2P data content originally requested by the first mobile device.

13. The computer program product of claim 10, further comprising forwarding the P2P data content in a cache on the serving gateway to a second mobile device in the RAN in a downlink transmission in response to a request by the second mobile device for the P2P data content originally requested by the first mobile device.

14. The computer program product of claim 10, wherein downloading the P2P data content uses a P2P mesh-pull protocol.

15. The computer program product of claim 10, wherein the P2P data content is selected from the group consisting of a multimedia stream, a video stream, an audio stream, a graphics file, an audio file, a text file, an executable file, a multimedia file, and combinations thereof.

16. A radio access network (RAN) server system for peer-to-peer (P2P) RAN communication, comprising:
a serving gateway (S-GW) with a peer-to-peer (P2P) data content manager for:
receiving P2P data content from other nodes in a P2P network;
forwarding the P2P data content to other nodes; and
transmitting, via a transmission station in a radio access network (RAN), the P2P data content to a mobile device for a downlink transmission;
wherein the serving gateway is a node in the P2P network, the serving gateway is coupled to a transmission station, and the P2P data content includes at least one P2P data packet.

17. The RAN server system of claim 16, further comprising:
the transmission station coupled to the serving gateway for providing uplink and downlink connectivity from the serving gateway to the mobile device, wherein an uplink transmission includes a request from the mobile device to the S-G for the P2P data content and a downlink transmission includes the P2P data content.

18. The RAN server system of claim 17, wherein the transmission station includes a base band unit (BBU) coupled to at least one of a plurality of remote radio unit (RRU) via an optical fiber network, wherein BBU connectivity can be dynamically switched from a first RRU to a second RRU.

19. The RAN server system of claim 16, wherein the mobile device is selected from the group consisting of a user equipment (UE) and mobile station (MS), and the transmission station is selected from the group consisting of an evolved Node B (eNodeB), a base station (BS), a base band unit (BBU), a remote radio head (RRH), a remote radio unit (RRU), a remote radio equipment (RRE), a relay station (RS), a radio equipment (RE), and combination thereof.

20. The RAN server system of claim 16, wherein the RAN is a radio access network (RAN) selected from the group consisting of a centralized RAN, a cooperative RAN, and a cloud RAN.

21. The RAN server system of claim 16, further comprising:
a mobility management entity (MME) for mobile device idle mode tracking and paging, data retransmissions to the mobile device, mobile device authenticating, inter-core network handover tracking of the mobile device, or combinations thereof.

22. The RAN server system of claim 16, wherein the RAN server system is coupled to the P2P network and an external packet data network via a packet data network (PDN) gateway (P-GW), wherein the P-GW performs policy enforcement, packet filtering for each user, charging support, lawful interception and packet screening.

23. The RAN server system of claim 22, wherein the external packet data network is an Internet.

24. A computer program product, comprising a non-transitory computer readable storage medium having a computer readable program code embodied therein, the computer readable program code adapted to be executed to implement a method for peer-to-peer (P2P) communication in a radio access network (RAN), comprising:
initially uploading peer-to-peer (P2P) data content from a first mobile device in a radio access network (RAN) in an uplink (UL) transmission to a serving gateway (S-GW) in the RAN;
storing the P2P data content at the S-GW;
forwarding the P2P data content stored at the S-GW to other mobile devices in a downlink (DL) transmission or to other nodes in a P2P network in response to a request for the P2P data content.

25. The computer program product of claim 24, wherein the request is to the first mobile device.

26. The computer program product of claim 24, wherein forwarding the P2P data content uses a P2P mesh-pull protocol.

27. The computer program product of claim 24, wherein the P2P data content is selected from the group consisting of a multimedia stream, a video stream, an audio stream, a graphics file, an audio file, a text file, an executable file, a multimedia file, and combinations thereof.
